(19) United States
(12) Patent Application Publication
(10) Pub. No.: US 2021/0285331 A1
(43) Pub. Date: Sep. 16, 2021

(54) TURBINE STATOR BLADE

(71) Applicant: TOSHIBA ENERGY SYSTEMS & SOLUTIONS CORPORATION, Kawasaki-shi (JP)

(72) Inventors: Norikazu TAKAGI, Kawasaki Kanagawa (JP); Tsuguhisa TASHIMA, Yokohama Kanagawa (JP); Daisuke NOMURA, Kawasaki Kanagawa (JP); Yoshifumi IWASAKI, Yokohama Kanagawa (JP); Shogo IWAI, Ota Tokyo (JP); Takahiro ONO, Ota Tokyo (JP)

(73) Assignee: TOSHIBA ENERGY SYSTEMS & SOLUTIONS CORPORATION, Kawasaki-shi (JP)

(21) Appl. No.: 17/182,400

(22) Filed: Feb. 23, 2021

(30) Foreign Application Priority Data
Mar. 13, 2020 (JP) 2020-044128

(51) Int. Cl. F01D 9/04; F01D 5/14; F01D 25/24

(52) U.S. Cl. CPC F01D 9/041; F01D 5/147; F05D 2260/221; F05D 2220/32; F05D 2240/12; F01D 25/24

(57) ABSTRACT

According to an embodiment, a turbine stator blade disposed in a working fluid flow path in a casing of a gas turbine, comprises: a blade effective part disposed in the working fluid flow path; an outer ring sidewall having a plate-shaped portion connecting to a radially outer end portion of the blade effective part, a front hook extending radially outward and circumferentially from the plate-shaped portion and having a tip fitting with the casing, a rear hook extending radially outward and circumferentially from the plate-shaped portion and having a tip fitting with the casing; and a reinforcing member that maintains an interval between the front hook and the rear hook; and an inner ring sidewall connected to a radially inner end portion of the blade effective part.

### CROSS-REFERENCE TO RELATED APPLICATION

This application is based upon and claims the benefit of priority from Japanese Patent Application No. 2020-044128 filed on Mar. 13, 2020, the entire content of which is incorporated herein by reference.

### FIELD

Embodiments of this invention relate to a turbine stator blade used for a gas turbine.

### BACKGROUND

Due to raising temperature of working fluid in gas turbines in recent years, cooling medium is supplied to hollow portions of rotor blades and stator blades, which often have hollow cooling structures produced by precision casting, to prevent temperature rise due to heat transfer from the working fluid.

In the case of stator blades of a gas turbine, the stator blades are arranged circumferentially where one or a plurality of blade effective parts are sandwiched between an outer ring sidewall at radial outside and an inner ring sidewall at radial inside and integrated with them. The stator blade is supported by a casing from radial outside with a front hook and a rear hook protruding radially outward fitted with the casing at the outer ring sidewall. Such outer ring sidewall with a front hook and a rear hook is disclosed in WO 2017/158637, the entire content of which is incorporated herein by reference.

The cooling medium is introduced from the casing side through the outer ring sidewall into the blade effective part. For this purpose, a circumferential cooling medium space is formed between the front hook and the rear hook to serve as a flow path connecting a supply flow path from the casing to the blade effective part of each stator blade.

Here, a CO₂ turbine among gas turbines requires a cooling structure similar to that of a conventional gas turbine, since its operating temperature is as high as that of the conventional gas turbine, and the rotor blades and stator blades have the hollow structure, as described above.

On the other hand, an operating pressure of the CO₂ turbine is as high as that of a steam turbine, and a pressure difference generated at the rotor blade and stator blade, that is, a pressure difference between the cooling medium and the working fluid, or a pressure difference between upward and downward of the rotor blade is about 10 times higher than these values in the conventional gas turbine. In the case of the steam turbine, for example, the rotor blade and stator blade are thick-walled and solid and are designed to withstand large pressure differences, but in the case of the CO₂ turbine, it cannot take the same approach as the steam turbine because the rotor blade and stator blade are required to have the cooling structure, as described above.

Thus, the stator blade of the CO₂ turbine is used at high-temperature and high-pressure conditions that are more severe in strength than the conventional gas turbine.

Now, regarding the stator blade, differential pressure of the working fluid flowing through a passage portion, that is, a main flow path, between upward and downward of the blade, causes bending force from the constrained outer ring sidewall to the inner ring sidewall, which has a free end. The outer ring sidewall is also subjected to force caused by a pressure difference between the cooling medium and the working fluid because pressure of the cooling medium is applied to a radially outer surface of the outer ring sidewall and pressure of the working fluid is applied to a radially inner surface thereof.

Particularly under high-temperature and high-pressure conditions where the stator blade of the CO₂ turbine is used, deformation due to the force caused by the differential pressure is large to cause high stress especially at a root of the blade at the outer ring sidewall, leading to damage if the structure is similar to that of the conventional gas turbine.

Due to a pressure difference between inside and outside across the outer ring sidewall in the radial direction, that is, the pressure difference between the working fluid and the cooling medium, a radial tip of the front hook and a radial tip of the rear hook displace in a direction where an interval between both tips narrows. As a result, the blade effective part and the inner ring sidewall are significantly deformed radially inward, that is, closer to a rotor shaft, reducing a gap between a seal portion of the turbine stator blade and the rotor shaft, and causing the seal portion to be in contact with the rotor shaft to be worn, increasing leakage and reducing turbine performance.

### BRIEF DESCRIPTION OF THE DRAWINGS

FIG. 1 is a partial sectional view illustrating an installation state of a turbine stator blade according to a first embodiment along a rotation axis of a rotor shaft of a gas turbine.

FIG. 2 is a view illustrating the turbine stator blade according to the first embodiment, taken along arrow lines II-II of FIG. 3 along a rotation axis of a rotor shaft.

FIG. 3 is a view illustrating the turbine stator blade according to the first embodiment, taken along arrow lines III-III of FIG. 2 looking from radially outside.

FIG. 4 are conceptual diagrams explaining an effect of the turbine stator blade 100 in the first embodiment, where FIG. 4A illustrates a state of pressure applied to the outer ring sidewall 120, FIG. 4B illustrates a deformation state in the case of the conventional configuration, and FIG. 4C illustrates the deformation state in the case of the present embodiment.

FIG. 5 is a view illustrating a turbine stator blade 100a according to a second embodiment, taken along arrow lines V-V of FIG. 6.

FIG. 6 is a view illustrating the turbine stator blade 100a according to the second embodiment, taken along arrow lines VI-VI of FIG. 5 looking from radially outside.

FIG. 7 is a view illustrating a turbine stator blade 100a according to a third embodiment, taken along arrow lines VII-VII of FIG. 8.

FIG. 8 is a view illustrating the turbine stator blade 100a according to the third embodiment, taken along arrow lines VIII-VIII of FIG. 7 looking from radially outside.

FIG. 9 is a longitudinal sectional view illustrating a turbine stator blade 100c according to a fourth embodiment, cut along a center of the blade effective part 110 in a thickness direction, including the front edge 111 of the blade effective part 110.

FIG. 10 are conceptual diagrams explaining an effect of the turbine stator blade in the fourth embodiment, where FIG. 10A illustrates a loading state added to the turbine stator blade, and FIG. 10B illustrates a deformed state due to the load.

FIG. 11 is a graph explaining requirements for the turbine stator blade in the fourth embodiment.

### DETAILED DESCRIPTION

Therefore, an object of embodiments of the present invention is to prevent degradation of the turbine performance due to the pressure difference between the working fluid and the cooling medium and ensuring soundness of the turbine stator blade.

According to an aspect of the present invention, there is provided a turbine stator blade disposed in a working fluid flow path in a casing of a gas turbine, comprising: a blade effective part disposed in the working fluid flow path; an outer ring sidewall having a plate-shaped portion connecting to a radially outer end portion of the blade effective part, a front hook extending radially outward and circumferentially from an upstream end portion side of the plate-shaped portion and having a tip fitting with the casing, a rear hook extending radially outward and circumferentially from a downstream end portion side of the plate-shaped portion and having a tip fitting with the casing, and a reinforcing member that maintains an interval between the front hook and the rear hook; and an inner ring sidewall connected to a radially inner end portion of the blade effective part.

With reference to the accompanying drawings, a turbine stator blade used for a gas turbine will be described. The parts that are the same as, or similar to, each other are represented by the same reference symbols and will not be described repeatedly.

### First Embodiment

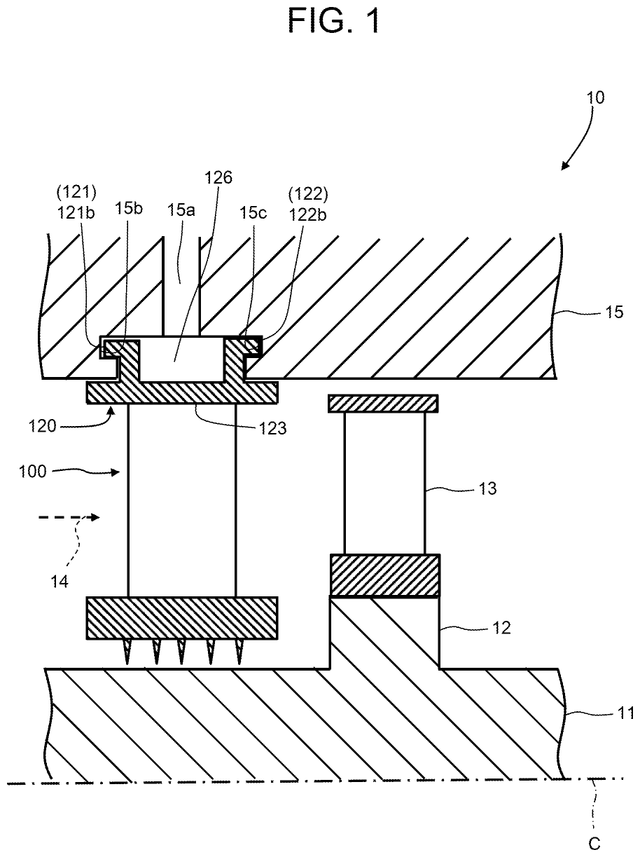

FIG. 1 is a partial sectional view illustrating an installation state of a turbine stator blade 100 according to a first embodiment along a rotation axis C of a rotor shaft of a gas turbine 10.

An annular working fluid flow path 14 is formed radially outside a rotor shaft 11 of the gas turbine 10 and radially inside a casing 15, where a working fluid generated by a non-illustrated combustor and sent into the gas turbine 10 is flowing. Here, the radial direction refers to a radial direction from a rotation axis of the rotor shaft 11, and radially inside refers to a direction toward or close to the rotor shaft 11, and radially outside refers to a direction away from the rotor shaft 11 or far from the rotor shaft 11.

A flow direction of the working fluid in the working fluid flow path 14 is a direction from left to right in FIG. 1. For convenience of explanation, an upstream side of the flow of the working fluid may be referred to as a front side and a downstream side as a rear side.

A plurality of rotor blades 13 are attached circumferentially on each of rotor disks 12 formed on the rotor shaft 11 and disposed with axial intervals therebetween to form a rotor blade cascade.

Immediately upstream of the rotor blades 13, the stator blades 100 are attached circumferentially to form a stator blade cascade. Each turbine stage is formed by each stator blade cascade and its immediate downstream rotor blade cascade. In FIG. 1, only one turbine stage is illustrated.

The stator blade 100 has a blade effective part 110, an outer ring sidewall 120, which is a radially outer portion of the blade effective part 110, and an inner ring sidewall 130, which is a radially inner portion of the blade effective part 110. One or a plurality of blade effective parts 110 are provided between one outer ring sidewall 120 and one inner ring sidewall 130 facing thereto.

The stator blade 100 is supported by the casing 15 at the outer ring sidewall 120.

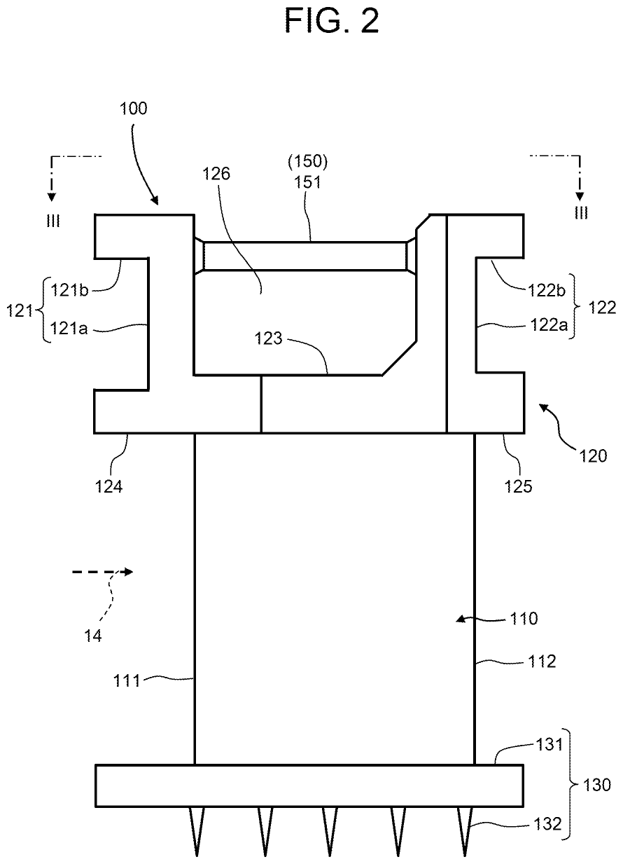

The outer ring sidewall 120 has a plate-shaped portion 123, a front hook 121, and a rear hook 122. The plate-shapedportion 123 is a portion that is coupled to a radially end portion of the blade effective part 110. The front hook 121 and rear hook 122 are formed to expand radially outward on front and rear portions of a radially outer surface of the plate-shaped portion 123, respectively. The front hook 121 and rear hook 122 are described in detail, with reference to FIG. 2, and are formed with a crocheted front hook protruding portion 121b and rear hook protruding portion 122b, respectively.

On the other hand, the casing 15 has a front hook receiving groove 15b for fitting the front hook protruding portion 121b of the front hook 121 and a rear hook receiving groove 15c for fitting the rear hook protruding portion 122b of the rear hook 122, each of which is circumferentially formed. The stator blade 100 is attached to and supportedby the casing 15 by fitting these portions.

The front hook 121 and the rear hook 122 of the outer ring sidewall 120 form a cooling medium space 126 that introduces a cooling medium and leads to the blade effective part 110. As a result, the cooling medium space 126 is circumferentially formed. The casing 15 has at least one cooling medium flow path 15a that leads the cooling medium to this cooling medium space 126.

A primary reason for providing the cooling medium space 126 is to reduce thermal impact on the casing 15. The blade effective part 110 of the turbine stator blade 100 is exposed to the working fluid at high temperature. The outer ring sidewall 120 is in contact with the working fluid on its radially inner surface and is in a high-temperature condition further due to heat conduction from the blade effective part 110. Although the outer ring sidewall 120 is fitted with the casing 15, a material of the casing 15 is generally not capable of enduring high temperature like a material of the turbine stator blade 100. Therefore, it is necessary to keep the temperature of the casing 15 in an appropriate temperature range.

A second reason for providing the cooling medium space 126 is to secure a supply flow path of the cooling medium to the blade effective part 110. That is, in many gas turbines, the blade effective part 110 is hollow and has a cooling medium flow path therein. This is because a circumferential annular flow path is required to supply the cooling medium to each of the turbine stator blades 100 arranged circumferentially.

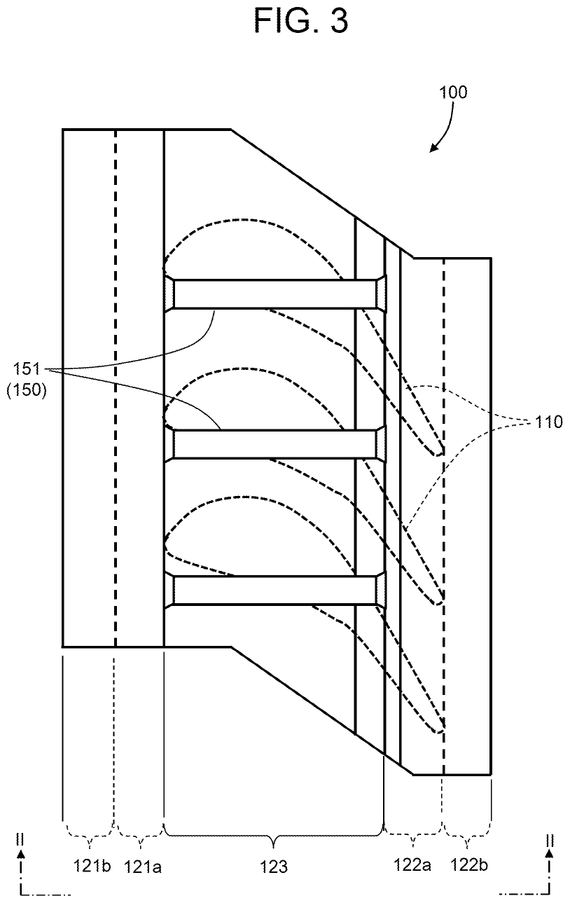

FIG. 2 is a view illustrating the turbine stator blade according to the first embodiment, taken along arrow lines II-II of FIG. 3 along a rotation axis of a rotor shaft, and FIG. 3 is a view taken along arrow lines III-III of FIG. 2 looking from radially outside. In most cases, the blade effective part 110 is hollow, and an opening is formed at the outer ring sidewall 120 that connects the flow path of the cooling medium in the blade effective part 110 and the cooling medium space 126, but this opening is not illustrated in FIG. 3. The blocks illustrated in these diagrams are connected circumferentially to form an annular stator blade cascade.

The inner ring sidewall 130 has a plate-shaped portion 131 extending axially and expanding circumferentially, and a plurality of labyrinth teeth 132 formed to be spaced apart from each other in the axial direction and expanding circumferentially on a radially inner surface of the plate-shaped portion 131. The plurality of labyrinth teeth 132 form a labyrinth coupled with a surface of the rotor shaft 11.

Next, the outer ring sidewall 120 is described in detail.

As described above, the outer ring sidewall 120 has the front hook 121 and rear hook 122, and plate-shaped portion 123, as illustrated in FIG. 2. The plate-shaped portion 123 is a portion connected to a radially outer end portion of the blade effective part 110 and extends concentrically in the circumferential direction. The front hook 121 and the rear hook 122 extend radially outward from the radially outer surface of the plate-shaped portion 123 and expand circumferentially. In the plate-shaped portion 123, a portion in an upstream direction from a portion connected to the front hook 121 is referred to as a front protruding portion 124 and a portion in a downstream direction from a portion connected to the rear hook 122 is referred to as a rear protruding portion 125.

The front hook 121 has a front hook wall portion 121a, which is the aforementioned radially outwardly extending portion, and the front hook protruding portion 121b, which is formed to protrude from a radially outer end portion of the front hook wall portion 121a toward the upstream side. The rear hook 122 has a rear hook wall portion 122a, which is the aforementioned radially outwardly extending portion, and the rear hook protruding portion 122b formed to protrude from a radially outer end portion of the rear hook wall portion 122a toward the downstream side.

As illustrated in FIG. 2 and FIG. 3, the front hook wall portion 121a and the rear hook wall portion 122a are formed to face each other, where three reinforcing rods 151 as reinforcing members 150 are provided to connect the surface of the front hook wall portion 121a on the side facing the rear hook wall portion 122a and the surface of the rear hook wall portion 122a on the side facing the front hook wall portion 121a, in other words, between the front hook 121 and the rear hook 122.

Radial positions where the reinforcing rods 151 are disposed are each preferably outside a center in the radial direction of the front hook 121 and the rear hook 122 and close to the outer end portion, so that the reinforcing rods 151 can function effectively.

The three reinforcing rods 151 as the reinforcing members 150 are disposed with circumferential intervals therebetween. The reinforcing rod 151 are attached to the front hook wall portion 121a and the rear hook wall portion 122a so that a direction of the reinforcing rod 151 is parallel to a turbine rotation axis C (FIG. 1) and attachment positions of the reinforcing rod 151 to the front hook wall portion 121a and the rear hook wall portion 122a are at radially outer portions of the front hook 121 and the rear hook 122.

In FIG. 3, the case of the three reinforcing rods 151 is illustrated, but the number of reinforcing rods 151 may be one or more than one, other than three rods.

The three reinforcing rods 151 as the reinforcing members 150 are formed by a material, in shape and size such that they are strong enough to withstand a compressive load caused by decreasing direction deformation of the interval between the front hook wall portion 121a and the rear hook wall portion 122a, and do not buckle.

The blade effective part 110 extends from its upstream end, an effective part front edge 111, to its downstream end, an effective part rear edge 112.

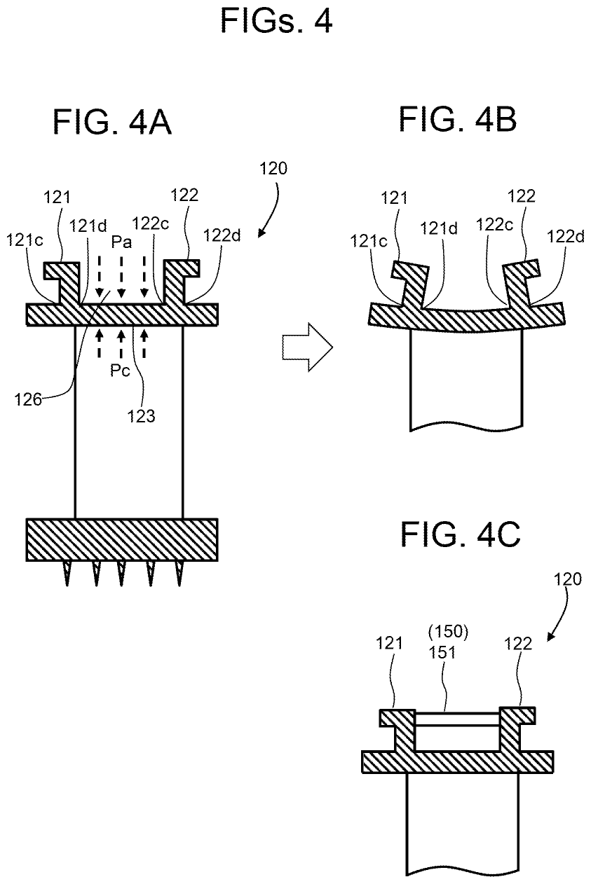

FIG. 4 are conceptual diagrams explaining an effect of the turbine stator blade 100 in the first embodiment, where FIG. 4A illustrates a state of pressure applied to the outer ring sidewall 120, FIG. 4B illustrates a deformation state in the case of the conventional configuration, and FIG. 4C illustrates the deformation state in the case of the present embodiment.

As illustrated in FIG. 4A, in an operating state of the gas turbine 10, pressure Pc of the working fluid is acting on the plate-shaped portion 123 of the outer ring sidewall 120 from the working fluid flow path 14 side at the radial inside of the plate-shaped portion 123. Pressure Pa of the cooling medium is acting from the cooling medium space 126 side at the radial outside of the plate-shaped portion 123.

Here, a load is added to the plate-shaped portion 123 so that the plate-shaped portion 123 protrudes radially inward because the pressure Pa of the cooling medium is higher than the pressure Pc of the working fluid.

Now, assuming that the outer ring sidewall 120 is not provided with the reinforcing members 150. In this case, the load caused by the pressure difference illustrated in FIG. 4A will cause the plate-shaped portion 123 to be deformed to protrude radially inward, as illustrated in FIG. 4B.

In such a state, regarding the front hook 121, compressive stress is generated at one of two portions of a front hook outer root portion 121c, which is an upstream portion of a root portion of the front hook wall portion 121a to the plate-shaped portion 123, and a front hook inner root portion 121d, which is a downstream portion of the root portion, and tensile stress is generated at the other portion.

Regarding the rear hook 122, compressive stress is generated at one of two portions of a rear hook inner root portion 122c, which is an upstream portion of a root portion of the rear hook wall portion 122a to the plate-shaped portion 123, and a rear hook outer root portion 122d, which is a downstream portion of the root portion, and tensile stress is generated at the other portion.

On the other hand, in the turbine stator blade 100 in this embodiment, the reinforcing rods 151 as the reinforcing members 150 are disposed between the front hook 121 and the rear hook 122 to prevent the deformation as illustrated in FIG. 4B.

That is, the problem which has been a conventional issue is prevented. The problem is as follows. The displacement of the radial tip of the front hook and the radial tip of the rear hook to narrow the distance due to the pressure difference between the inside and the outside across the outer ring sidewall in the radial direction, namely, the pressure difference between the working fluid and the cooling medium, causes the large deformation of the blade effective part and the inner ring sidewall radially inward, that is, toward the side close to the rotor shaft, and the gap between the seal portion of the turbine stator blade and the rotor shaft is reduced, then the seal portion is in contact with the rotor shaft to be worn to increase leakage, resulting in that the turbine performance is degraded. Preventing the problem leads to ensuring the soundness of the turbine stator blade 100.

### Second Embodiment

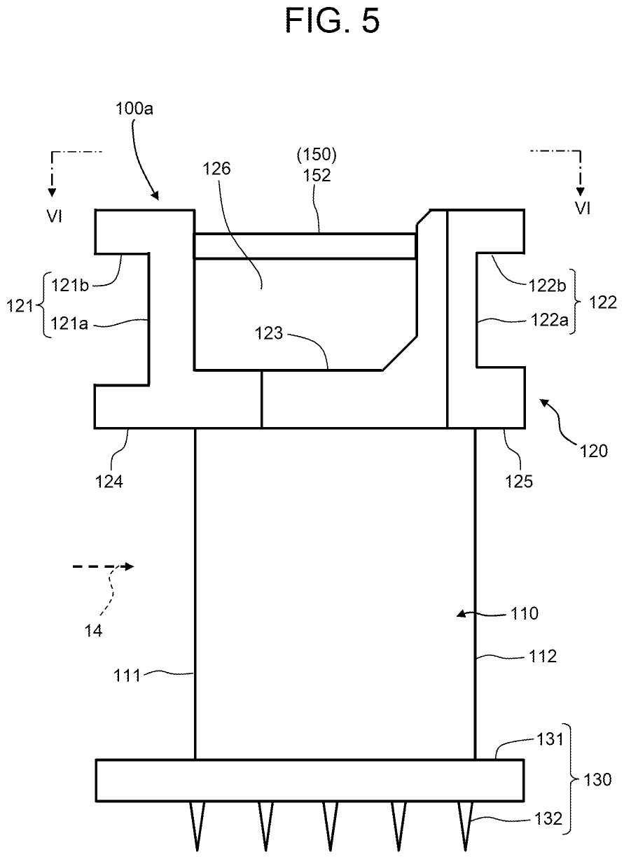

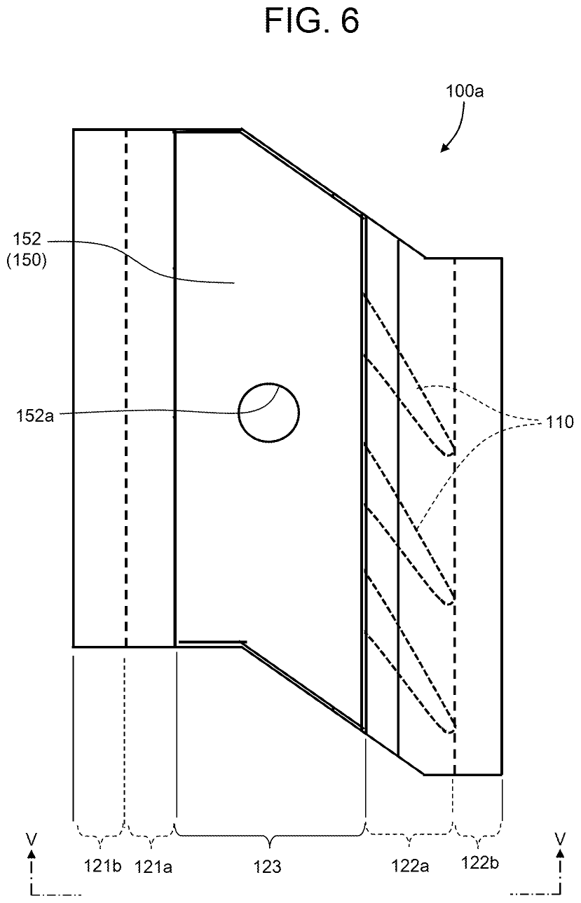

FIG. 5 is a view illustrating a turbine stator blade 100a according to a second embodiment, taken along arrow lines V-V of FIG. 6, and FIG. 6 is a view taken along arrow lines VI-VI of FIG. 5 looking from radially outside.

This second embodiment is a modification of the first embodiment, differing from the first embodiment in that the turbine stator blade 100a has a reinforcing outer plate 152 as the reinforcing member 150 instead of the reinforcing rods 151 in the first embodiment as the reinforcing members 150, and is otherwise similar to the first embodiment.

FIG. 6 illustrates the case where a ventilation hole 152a is formed at the reinforcing outer plate 152. The ventilation hole 152a is a hole to allow the cooling medium that has passed through the cooling medium flow path 15a (FIG. 1) formed at the casing 15 to flow into the cooling medium space 126 (FIG. 5) and is formed at the reinforcing outer plate 152 of a part of the turbine stator blades 100a. In FIG. 6, the ventilation hole 152a is illustrated as a single circular shape, but the ventilation holes 152a may be of other shapes and numbers.

The reinforcing outer plate 152 as the reinforcing member 150 is attached so as to connect a surface of the front hook wall portion 121a facing the rear hook wall portion 122a and a surface of the rear hook wall portion 122a facing the front hook wall portion 121a.

The reinforcing outer plate 152 as the reinforcing member 150 is a single plate and has a shape of a flat plate or a cross sectional shape of part of a concentric circle. The reinforcing outer plate 152 is attached to the front hook wall portion 121a and the rear hook wall portion 122a so that a longitudinal direction of the reinforcing outer plate 152 is parallel to the turbine rotation axis C (FIG. 1) and extends circumferentially, and attachment positions of the reinforcing outer plate 152 to the front hook wall portion 121a and rear hook wall portion 122a are radially outer portions of the front hook 121 and the rear hook 122.

The reinforcing outer plate 152 is not limited to the single plate but may be, for example, a plurality of flat plates divided in the circumferential direction or in the axial direction.

In the turbine stator blade 100a in the present embodiment, the reinforcing outer plate 152 as the reinforcing member 150 is disposedbetween the front hook 121 and the rear hook 122, preventing deformation such that the front hook wall portion 121a and the rear hook wall portion 122a are close together, as in the first embodiment, thereby preventing degradation of the turbine performance due to increased leakage and ensuring soundness of the turbine stator blade 100a.

### Third Embodiment

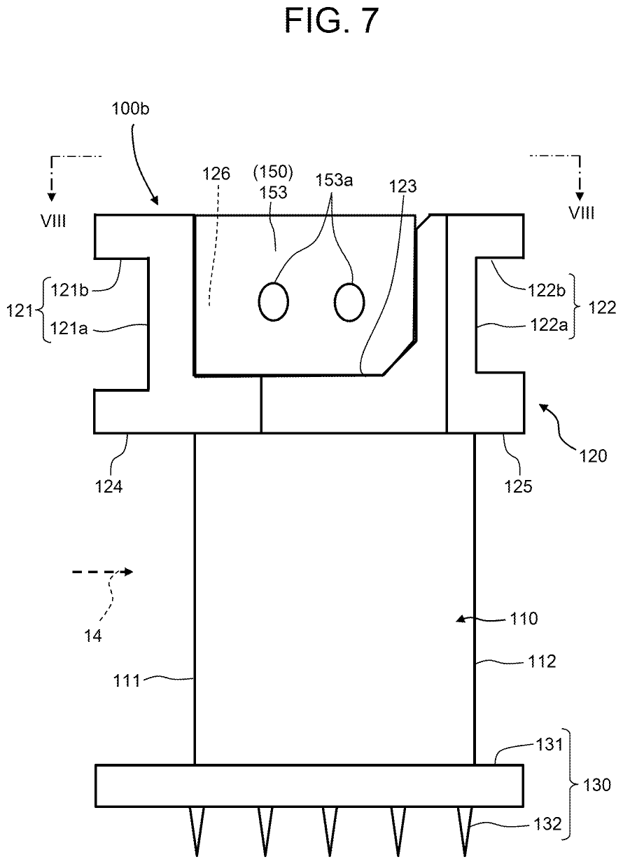

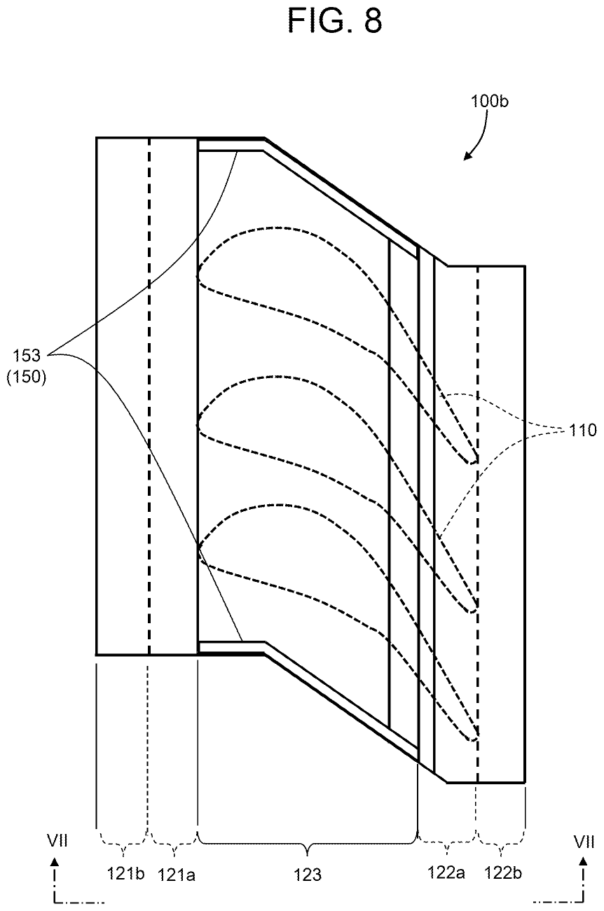

FIG. 7 is a view illustrating a turbine stator blade 100a according to a third embodiment, taken along arrow lines VII-VII of FIG. 8, and FIG. 8 is a view taken along arrow lines VIII-VIII of FIG. 7 looking from radially outside.

The third embodiment is a modification of the first embodiment, differing from the first embodiment in that the turbine stator blade 100b has two reinforcing side plates 153 as the reinforcing members 150 instead of the reinforcing rods 151 in the first embodiment as the reinforcing members 150, and is otherwise similar to the first embodiment.

At each of circumferential both end portions of the outer ring sidewall 120, the reinforcing side plate 153 is disposed so as to connect with each of the circumferential end portions of: a surface of the plate-shaped portion 123 on the cooling medium space 126 side at the radial outside; a surface of the front hook wall portion 121a of the front hook 121 on the cooling medium space 126 side; and a surface of the rear hook wall portion 122a of the rear hook 122 on the cooling medium space 126 side. Therefore, the reinforcing side plate 153 is in a form of a bent flat plate.

The reinforcing side plate 153 has ventilation holes 153a (FIG. 7) to communicate between the spaces 126 for the cooling medium of turbine stator blades 100b. The number of ventilation holes 153a may be one or three or more. The shape of the ventilation hole 153a may be circular as illustrated in FIG. 8, or other shapes such as polygonal, for example.

FIG. 7 illustrates an example of the case where the reinforcing side plate 153 is connected to the plate-shaped portion 123, the front hook 121, and the rear hook 122, but is not limited thereto. That is, the reinforcing side plate 153 may not be connected to the plate-shaped portion 123 as long as it is at least connected to portions of the front hook 121 and rear hook 122 that are respectively at the radial outside than the center. In this case, there is no need to form the ventilation hole 153a, since a gap between the reinforcing side plate 153 and the plate-shaped portion 123 becomes a ventilation passage.

Although the case where the reinforcing side plates 153 are respectively provided at the circumferential both end portions of the outer ring sidewall 120 is exemplified, the reinforcing side plate 153 may be provided at an intermediate position in the circumferential direction. Alternatively, the reinforcing side plates 153 may be provided at both the end portions and the intermediate portion. Besides, the reinforcing side plate 153 does not necessarily have to be bent.

In the turbine stator blade 100b in this embodiment, since the reinforcing side plates 153 as the reinforcing members 150 are disposed between the front hook 121 and the rear hook 122 as in the first embodiment, deformation such that the front hook wall portion 121a and the rear hook wall portion 122a are close together is prevented, thereby preventing degradation of the turbine performance due to increased leakage and ensuring soundness of the turbine stator blade 100b.

### Fourth Embodiment

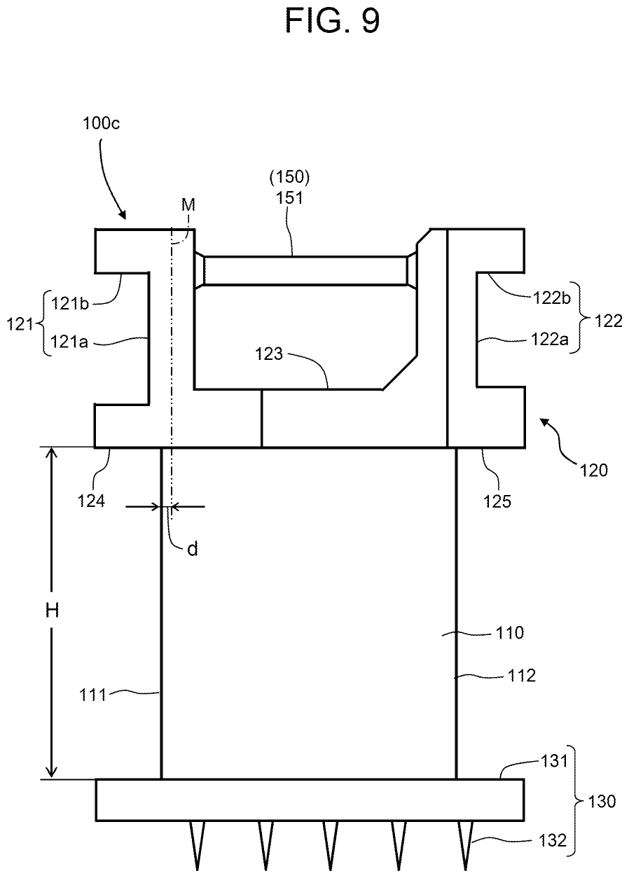

FIG. 9 is a longitudinal sectional view illustrating a turbine stator blade 100c according to a fourth embodiment, cut along a center of the blade effective part 110 in a thickness direction, including the front edge 111 of the blade effective part 110.

The present embodiment is a modification of the first embodiment. In the present embodiment, axial positions of the front edge 111 of the blade effective part 110 and the outer ring sidewall 120 are in a predetermined relationship.

A difference between the axial position of a radially outer end portion of the blade effective part 110, that is, the front edge 111 at a joint portion with the plate-shaped portion 123 of the outer ring sidewall 120, and the axial position of a center line M in the thickness direction of the front hook wall portion 121a of the front hook 121 of the outer ring sidewall 120, that is, a displacement amount of the axial positions between the front edge 111 and the center line M is set as “d”. When the effective part front edge 111 is on the upstream side of the working fluid than the center line M, “d” is set as positive, andwhen the effective part front edge 111 is on the downstream side of the working fluid than the center line M, “d” is set as negative. A height of the blade effective part 110, that is, a radial length thereof is set as H. A degree of positional displacement 5 is expressed as (d/H).

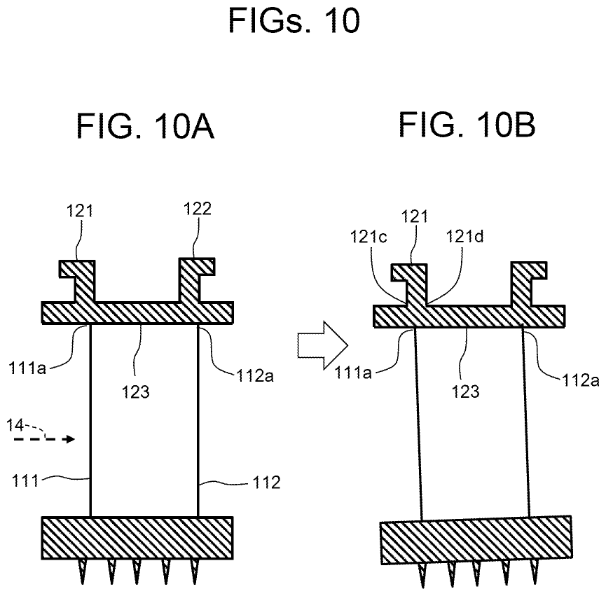

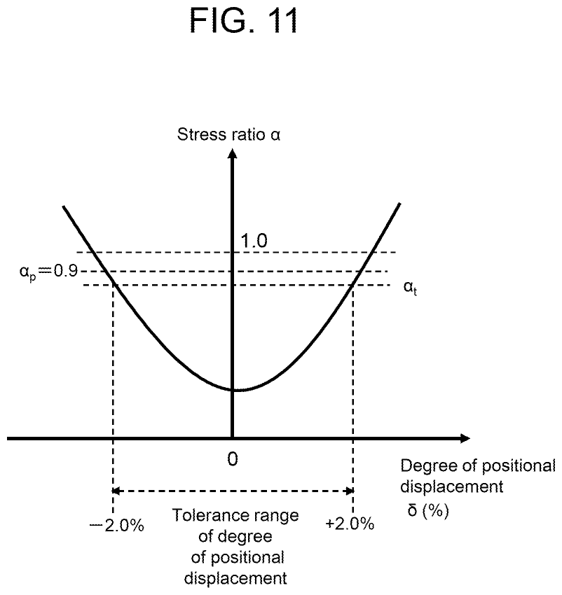

In the present embodiment, a predetermined relationship between the degree of positional displacement 5 and a stress in the plate-shaped portion 123 generated at a joint portion 111a (FIG. 10) of the outer ring sidewall 120 and an effective part front edge 111 of the blade effective part 110 is established. Contents of the predetermined relationship will be explained later, with reference to FIG. 11.

FIG. 10 are conceptual diagrams explaining an effect of the turbine stator blade in the fourth embodiment, where FIG. 10A illustrates a loading state added to the turbine stator blade, and FIG. 10B illustrates a deformed state due to the load.

Due to the working fluid flowing through the working fluid flow path 14, a pressure difference is generated between forward and backward in the axial direction of the effective part of the blade effective part 110. That is, the pressure on the effective part front edge 111 side is higher than that on the effective part rear edge 112 side, which causes a load on the blade effective part 110 from an upstream side to a downstream side. The turbine stator blade 100 is supported by the casing 15 (FIG. 1) on the outer ring sidewall 120 side, and the inner ring sidewall 130 side, that is, the radial inside is a free end.

The turbine stator blade 100 is therefore deformed such that the inner ring sidewall 130 side moves downstream. As a result of this deformation, tensile stress is generated on an axially upstream side and compressive stress is generated on an axially downstream side at a connection portion between the blade effective part 110 and the outer ring sidewall 120. That is, the tensile stress is generated at the effective part front edge outer root portion 111a, which is the connection portion of the effective part front edge 111 with the plate-shaped portion 123, and the compressive stress is generated at the effective part rear edge outer root portion 112a, which is the connection portion of the effective part rear edge 112 with the plate-shaped portion 123.

Here, as explained in the first embodiment with reference to FIG. 4, when the outer ring sidewall 120 is not provided with the reinforcing member 150, the compressive stress is generated at one of the front hook outer root portion 121c and the front hook inner root portion 121d regarding the front hook 121, and the tensile stress is generated at the other root portion, respectively.

On the other hand, when the outer ring sidewall 120 is provided with the reinforcing member 150, the interval between the front hook 121 and rear hook 122 can be maintained and the deformation of the outer ring sidewall 120 due to the pressure difference between the inside and outside in the radial direction of the reinforcing member 150 can be suppressed, and the deformation such that the blade effective part and the inner ring sidewall come close to the rotor shaft can be prevented, but the root portions of the front hook 121 and rear hook 122 of the outer ring sidewall 120 will be in complex stress states.

Especially, since the front hook outer root portion 121c is subject to the tensile stress, it is preferable to prevent the generation of other stresses as much as possible, and avoid increasing combined stress.

As mentioned above, the outer ring sidewall 120 itself is under stress. At the joint portion between the front hook 121 side and the plate-shaped portion 123, the stresses in the thickness direction of the front hook 121 are considered to be reversed in direction between a front surface and a rear surface of the front hook wall portion 121a, that is, if one is in a compression direction, the other is in a tensile direction. Therefore, near the front hook 121, the stress is considered to be almost zero at an intermediate portion in the thickness direction of the front hook wall portion 121a, that is, at a position corresponding to the center line M.

Thus, when the position of the front edge 111 of the blade effective part 110 is in a relation of substantially coinciding with the axial position of the axial center of the front hook wall portion 121a of the outer ring sidewall 120 in the thickness direction, the stress at the outer ring sidewall 120 can be avoided from superimposing the tensile stress generated at the aforementioned effective part front edge outer root portion 111a.

FIG. 11 is a graph explaining requirements for the turbine stator blade in the fourth embodiment. A horizontal axis is the degree of positional displacement δ (%), that is, a ratio of the axial displacement “d” of the position of the effective part front edge 111 at the effective part front edge outer root portion 111a from the center line M to the height H of the blade effective part 110 (d/H), and a vertical axis is a stress ratio a to an allowable stress.

When a stress generated at the plate-shaped portion 123 at the joint portion 111a (FIG. 10) with the front hook 121 between the outer ring sidewall 120 and the blade effective part 110 is σa, and the allowable stress is σp, the stress ratio a is expressed as σa/σp.

Here, the allowable stress op is defined as a stress where a degree of exceeding a proof stress is equal to a degree of replacement frequency of a common gas turbine component. That is, in gas turbines, especially in CO₂ turbines driven by high-temperature and high-pressure working fluid, it is commonly possible for local stresses to exceed the proof stress of a material of the component. As a result, plastic strains accumulate, and the component is generally replaced periodically in consideration of a fatigue life to continue operation.

Therefore, when the high stress is localized, as described above, the allowable stress op here may be a stress value that exceeds, for example, 0.2% proof stress of the material. As for the aforementioned replacement frequency of the component, when the replacement frequency of the component, in general, is every 5 to 10 years, for example, an average or intermediate value of the interval may be used, or the shortest 5 years may be used.

The curve illustrated in FIG. 11 represents a value of the ratio α to the allowable stress σp for the stress oa generated at the plate-shaped portion 123 at the joint portion 111a (FIG. 10) with the front hook 121 between the outer ring sidewall 120 and the blade effective part 110. As illustrated in FIG. 11, as an absolute value of the ratio of the axial displacement “d” of the position of the effective part front edge 111 from the center line M to the height H of the blade effective part 110, that is, the degree of positional displacement δ (d/H (%)), increases forward and backward in the axial direction, the stress ratio α, which is the ratio to the allowable stress σp, increases.

Now, taking into account manufacturing tolerances, including casting of the stator blade 100c, a tolerance range of the degree of positional displacement δ (%) is set to a range of minus 2% or more and plus 2% or less. In this case, αₜ is defined as a greater value between the stress ratio α when the degree of positional displacement δ is minus 2% and the stress ratio a when it is plus 2%. Here, a reference value αₚ is assumed to be, for example, 0.9 with a margin of error against 1.0. In this case, the stress ratio αₜ, which is smaller than the reference value αₚ, can be obtained.

To further securing for structural strength margins, the allowable stress op may be set to a value of, for example, 0.2% of the material's proof stress, or 0.9 times that value, or the like, thereby confirming that the conditions described above are met.

As mentioned above, in the turbine stator blade 100c in this fourth embodiment, the soundness of the turbine stator blade 100c can be ensured by bringing the front edge 111 of the blade effective part 110 as close as possible to the axial position of the outer ring sidewall 120 so that the stress at the outer ring sidewall 120 is not superimposed on the tensile stress generated at the effective part outer root portion 111a described above.

### Other Embodiments

While certain embodiments of the present invention have been described above, these embodiments have been presented by way of example only, and are not intended to limit the scope of the invention.

The embodiments may be combined with each other.

The embodiments may be embodied in other various forms. Various omissions, replacements and changes may be made without departing from the spirit of the invention.

The above-described embodiments and variants thereof are within the scope and spirit of the invention, and are similarly within the scope of the invention defined in the appended claims and the range of equivalency thereof.

What is claimed:

1. A turbine stator blade disposed in a working fluid flow path in a casing of a gas turbine, comprising:
a blade effective part disposed in the working fluid flow path;
an outer ring sidewall having
a plate-shaped portion connecting to a radially outer end portion of the blade effective part,
a front hook extending radially outward and circumferentially from an upstream end portion side of the plate-shaped portion and having a tip fitting with the casing,
a rear hook extending radially outward and circumferentially from a downstream end portion side of the plate-shaped portion and having a tip fitting with the casing, and
a reinforcing member that maintains an interval between the front hook and the rear hook; and
an inner ring sidewall connected to a radially inner end portion of the blade effective part

2. The turbine stator blade according to claim 1, wherein
the reinforcing member connects at least a vicinity of a radially outer end portion at the front hook and a vicinity of a radially outer end portion at the rear hook.

3. The turbine stator blade according to claim 1, wherein
the reinforcing member includes at least one rod-shaped reinforcing rod connecting the vicinity of the radially outer end portion at the front hook and the vicinity of the radially outer end portion at the rear hook.

4. The turbine stator blade according to claim 1, wherein
the reinforcing member has a reinforcing outer plate connecting the vicinity of the radially outer end portion at the front hook and the vicinity of the radially outer end portion at the rear hook and expanding circumferentially.

5. The turbine stator blade according to claim 4, wherein
the reinforcing outer plate has a ventilation hole formed therein.

6. The turbine stator blade according to claim 1, wherein
the reinforcing members have reinforcing side plates that are arranged at both circumferential ends of the outer ring sidewall and rod-shaped, and connect the vicinity of the radially outer end portion at the front hook and the vicinity of the radially outer end portion at the rear hook, and expand radially inward.

7. The turbine stator blade according to claim 6, wherein
each of the reinforcing side plates has a ventilation hole therein when the reinforcing side plate connects also with the plate-shaped portion.

8. The turbine stator blade according to claim 1, wherein
a degree of positional displacement, which is a ratio of displacement between an axial position of an axial upstream tip of the blade effective part and a position of a center of a wall thickness of a portion extending radially and circumferentially from the plate-shaped portion of the front hook to a radial height of the blade effective part, is within a predetermined tolerance value.

9. The turbine stator blade according to claim 8, wherein
the predetermined tolerance value is minus 2% or more and plus 2% or less.
